(19) United States
(12) Patent Application Publication
(10) Pub. No.: US 2005/0035655 A1
(43) Pub. Date: Feb. 17, 2005

(54) Track with offset drive lugs and drive wheel therefore

(75) Inventors: Harold K. Beckstrom, Lisbon, ND (US); Larry E. Albright, Gwinner, ND (US); Dan Frederick, Forman, ND (US); Michael E. Fitzgerald, Moorhead, MN (US); Bruno Fillion, Magog (CA)

Correspondence Address: Nickolas E. Westman;Westman, Champlin & Kelly, Suite 1600, 900 Second Avenue South, Minneapolis, MN, 55402-3319, US

(73) Assignees: Clark Equipment Company, Woodcliff Lake, NJ (US); Camoplast Inc., Sherbrooke (CA)

(21) Appl. No.: 10/916,158

(22) Filed: Aug. 11, 2004

Related U.S. Application Data
(60) Provisional application No. 60/494,668, filed on Aug. 13, 2003.

(51) Int. Cl. B62D 55/275

(52) U.S. Cl. 305/173; 305/195

(57) ABSTRACT

A drive track for a tracked vehicle has drive lugs on the interior side that are made in two rows, one row adjacent each of the lateral sides of the track and spaced apart on opposite sides of the longitudinal center plane of the track. The first row has lugs spaced a selected distance on center, and the second row lugs are spaced the same distance but offset one-half of the distance between the lugs in the first row along the length of the track. A drive sprocket or wheel has two sections, each with drive bars that are annularly offset from the other the same amount as the track lugs so that the rows of track lugs are driven by the drive wheel sections.

This Application refers to and claims priority on U.S. Provisional Application Ser. No. 60/494,668, filed Aug. 13, 2003, the content of which is incorporated by reference.

### BACKGROUND OF THE INVENTION

The present invention relates to the use of a track laying drive track that provides a positive drive method for rubber tracks, with the track having interior teeth or lugs which are engaged by a drive sprocket. There are two rows of longitudinally spaced drive lugs laterally separated along a longitudinal center line of the track. The lugs on one row are offset one-half the lug spacing from the lugs in the other row and laterally separated drive wheels or sprockets drive the track. The drive bars on the wheels or sprockets are also offset from each other to match the offset between the rows of lugs.

In the past, molded rubber or polymeric tracks have been used for crawler-type tractors, but have used single rows of drive lugs that were centered in the lateral direction of the track. The drive wheels or sprockets used were single pitch or, in other words, had uniform spacing between the teeth. If drive wheels or sprockets with two side by side rows of teeth were used, the teeth were aligned transversely. Track drives generally have been arranged to be single sprockets that drive through lugs on the rubber track.

### SUMMARY OF THE INVENTION

The present invention relates to a molded, endless track for a vehicle that has lugs on the interior side that are engaged by drive wheels or sprockets. The lugs are arranged in two longitudinal rows, separated laterally from each other along the central plane of the track. The lugs in each row have a spacing in longitudinal direction, and the lugs in one row are offset one-half of the spacing from the lugs in the other row.

A pair of drive wheels, or sprockets, are on a common axis for rotation, but also are separated laterally to leave a space along the central longitudinal axis of the track. The sprockets have wheel webs with rounded, laterally wider drive teeth or bars at the outer periphery. The drive teeth or bars on one sprocket or drive wheel of a drive wheel assembly are annularlly offset from the drive teeth or bars on the other drive wheel to correspond to the offset of the drive lugs. The radial center lines of the drive teeth or bars of the drive wheels radially of the axis of rotation of one drive wheel are offset from the radial center lines of the drive teeth or bars of the other drive wheel on the opposite side of the center plane of the track.

Bogie wheels, or track guide wheels, are provided to support the ground engaging portion of the track. Each bogie wheel has three support flanges engaging the interior surface of the track. There is one support flange in a center path between the rows of lugs and support flanges along paths at both of the outside edges of the rows of drive lugs on the track. The outer support flanges are just inside the lateral side edges of the track.

Having the offset drive lugs on opposite sides of center plane of the track provides for transmission of power to the track that is more continuous and uniform. The staggered drive lugs act as a fine pitch sprocket, with twice the number of teeth, but the staggered drive lugs allow the individual lugs to remain a larger size. The offset lugs and drive wheel or sprocket design also improves the debris shedding performance, since debris is allowed to be pushed outward instead of being blocked by an adjacent portion of a lug or another aligned lug.

The offset lug design also allows the tread lugs (exterior) of the track to be placed on the track relative to the drive lugs in an offset pattern that enhance the ride performance of the track.

### BRIEF DESCRIPTION OF THE DRAWINGS

FIG. 1 is a side elevational view of a typical track assembly utilizing drive wheels and track drive lugs made according to the present invention;

FIG. 2 is a sectional view taken along line 2--2 in FIG. 1;

FIG. 3 is a plan view of the interior surface of the track taken generally along line 3--3 in FIG. 1;

FIG. 4 is a perspective view of a drive wheel and drive case used with the invention;

FIG. 5 is an enlarged side view of a drive wheel used with the track;

FIG. 6 is a perspective view of a modified drive for the track of the present invention;

FIG. 7 is a view similar to FIG. 6 with parts broken away; and

FIG. 8 is a plan view of the exterior of the track of FIG. 1.

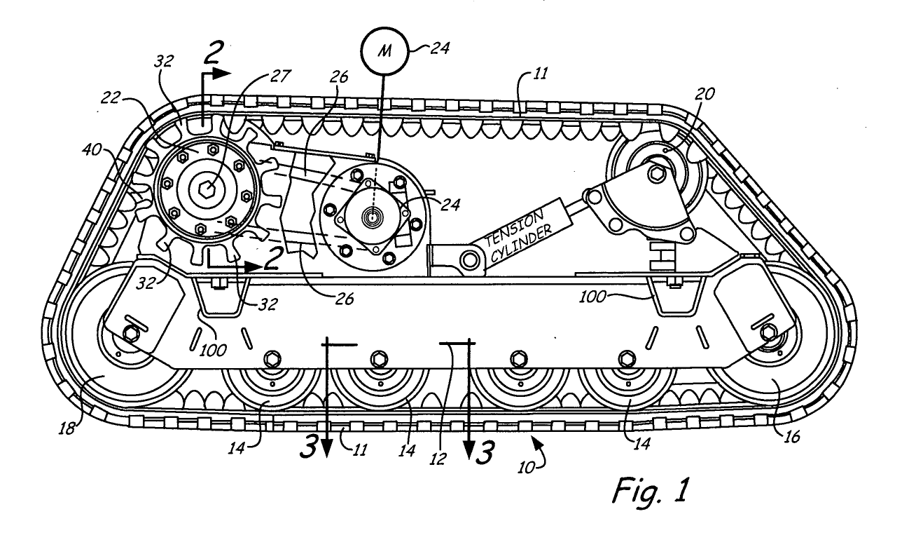

### DETAILED DESCRIPTION OF THE PREFERRED EMBODIMENTS

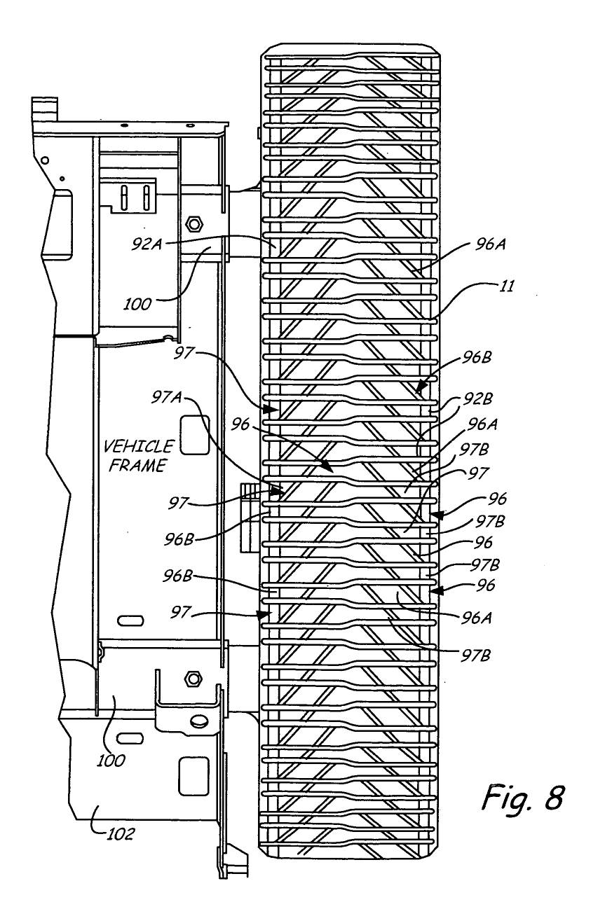

A vehicle track drive assembly indicated generally at 10 includes an endless track 11 supported on a track frame 12 that is attached to a vehicle, shown only schematically in FIG. 8. The track frame 12 supports bogie wheels 14, a front idler wheel 16, a rear idler wheel 18, an upper front idler track tension creating wheel 20, and a track drive wheel assembly 22. The drive wheel assembly is driven from a motor, as shown, a hydraulic motor 24, to move the track around in its closed path on the guide wheels and bogie wheels.

A chain, shown schematically at 26, is used between a support on a shaft driven by the motor 24 and a drive sprocket 25A drivably mounted on a drive wheel assembly drive shaft 25 that is rotatably mounted in a chain drive case 38.

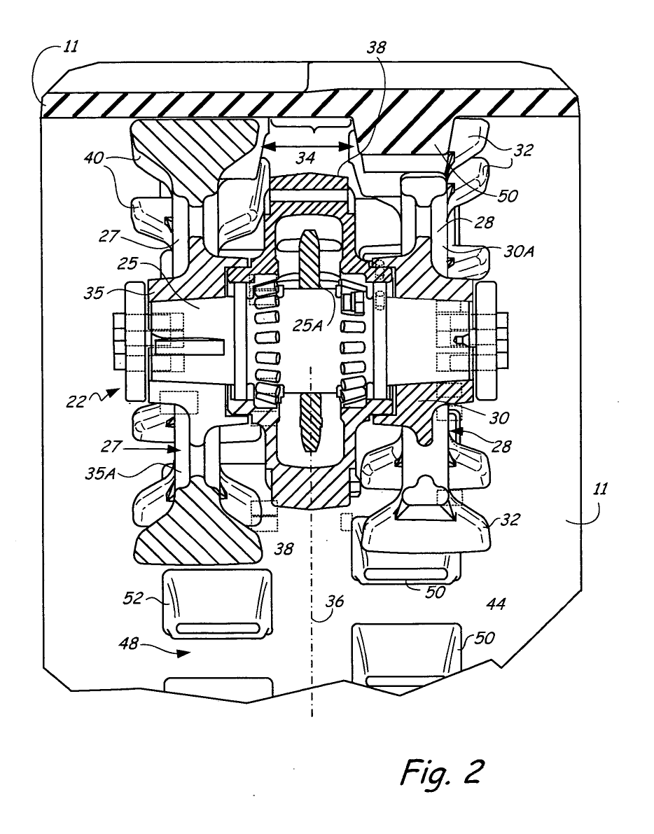

The drive wheel assembly 22 is a split drive wheel with two spaced halves forming drive wheel sections 27 and 28. The spaced sections leave an open path in the center of the wheel assembly. It is shown in FIG. 2. The drive wheel assembly 22 includes a first side drive wheel section 27 and a second side drive wheel section 28, and as shown the drive wheel sections are drivably mounted on the outwardly extending ends of drive shaft 25. The ends of drive shaft 25 extend outside of chain drive case 38.

The drive wheel section 28 has a center drive hub 30, and a radially extending plate or support 30A that supports track drive bars or teeth 32 at the periphery of the drive wheel section 28. The drive bars 32 on the drive wheel section 28 are spaced laterally from the vertical center plane 36 of the track 11, and extend laterally on opposite sides of plate or support 30A.

The second drive wheel section 27 has a center drive hub 35 that is mounted on an opposite end of shaft 25 from hub 30. The drive wheel section 27 has a radially extending plate or support 35A drive bars or teeth 40 that are spaced laterally from track center plane 36 on the opposite side of the plane 36 from drive bars 32. The drive bars 40 also extend laterally on opposite sides of the plate or support 35A. The space 34 between the drive bars 32 and 40 in the center portion of the track provides a location for the chain drive case 38 for the chain 26 and sprocket 25A.

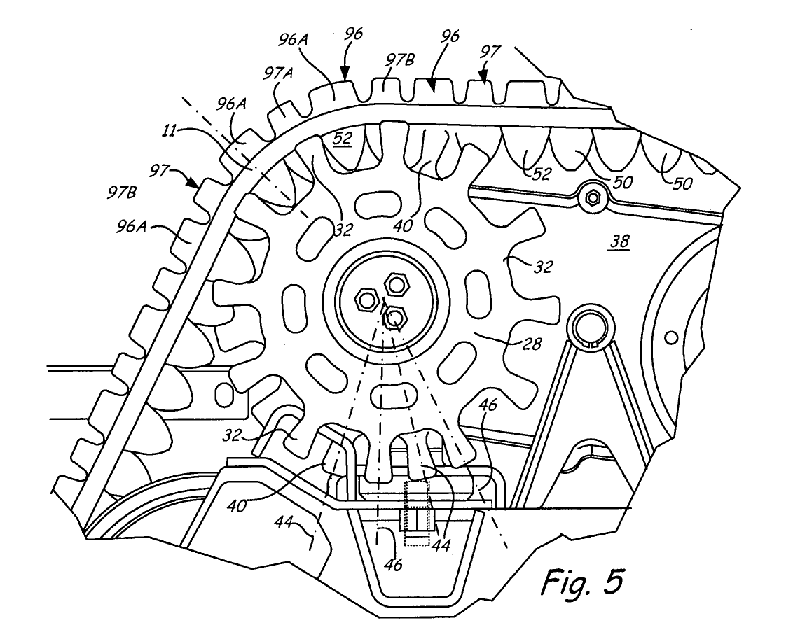

The drive bars 40 that drive on drive wheel section 27 are offset annularly from the drive bars 32, so that the radial planes 44 centered on each of the drive bars 40 is midway between the two radial central planes 46 of two adjacent drive bars 32 (see FIG. 5).

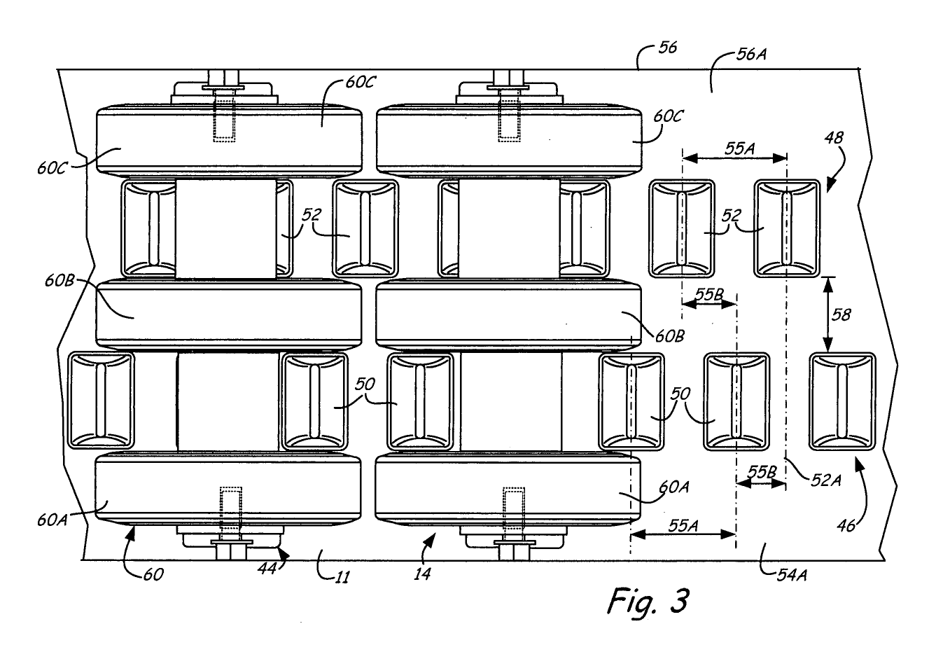

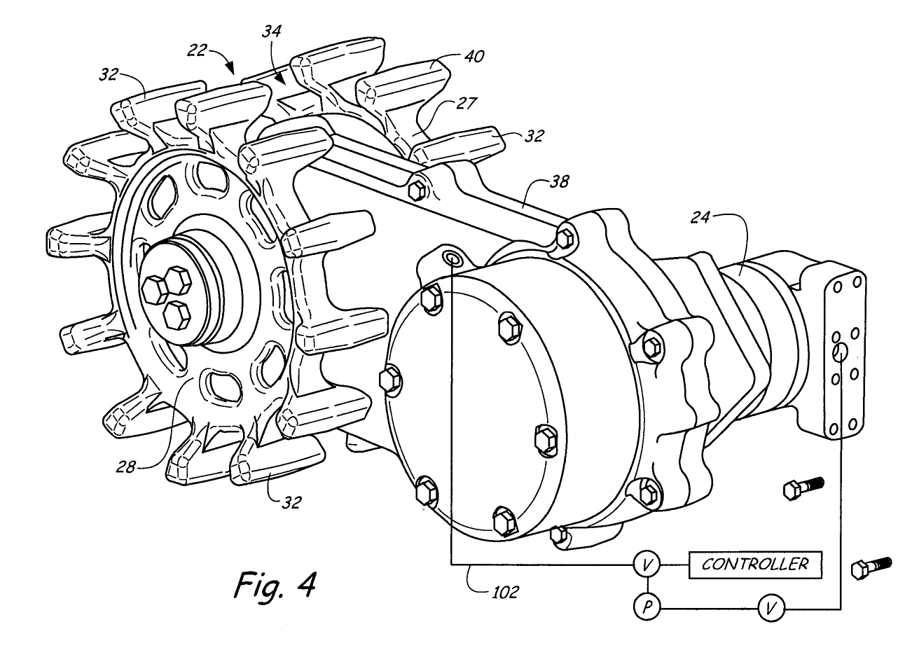

The track 11 is rubber or polymeric material (synthetic rubber), preferably steel cable or wire reinforced and formed (or molded) in an endless loop. The track is made to have two rows of molded drive lugs unitarily formed with the track that are laterally offset from each other. As can be seen in FIG. 3, the track 11 is provided with two longitudinally extending rows 46 and 48 of drive lugs 50 and 52. The drive lugs 50 and 52 have a longitudinal spacing corresponding to the annular spacing between the drive bars 32 on drive wheel section 28 and drive bars 40 on drive wheel section 27. The lugs 50 in row 44 are driven by the drive bars 32, and the lugs 52 are driven by the drive bars 40. The drive bars 32 and 40 and the drive lugs 50 and 52 terminate at ends spaced from the lateral edges 54 and 56 of the track 11 to leave a smooth surface 54A and 56A along the inner side surfaces of the track. There is a space 58 between the rows of lugs leaving a smooth inner track surface, centered on the longitudinal axis of the track, and this corresponds to the space 34, as shown in FIG. 2.

The drive lugs 50 and 52 have transverse center axes that are spaced the same distance as the spacing of the drive bars. The transverse axes 50A and 52A of the lugs are offset one-half of the total spacing between the lugs in the same row. The total spacing between the lugs in the same row is indicated at 55A in FIG. 3, and the offset is indicated at 55B. Thus, the drive bars 40 will engage the lugs 52, and the drive lugs 32 will engage lugs 50, for driving the track.

The bogie wheels and idler wheels are made so that they will support the track along the lateral edges and in the track center, by having three separate, smooth surface discs or wheel segments. In FIG. 3, a typical bogie or idler guide wheel is shown with wheel or roller 60 having a support flange on a wheel 60A for track space 54A, 60B for the center space 58, and 60C for the track space 56A on the side of the track opposite from bogie or idler wheel segment 60A.

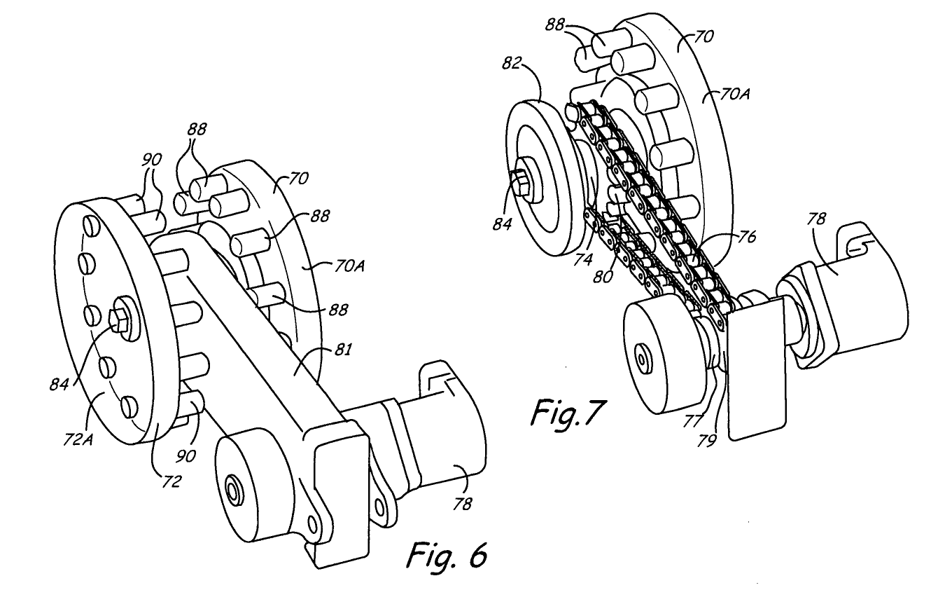

In FIGS. 6 and 7 a modified drive is shown schematically, and in this instance, there are drive wheel sections 70 and 72 mounted on a single hub 74, with flanges 70A and 72A that ride along and support the edge spaces 54A and 56A of the track on the outside of rows of the lugs 50 and 52 in the same way that the drive wheel segments 60A and 60C run. In this form, the chain 76 is driven by a motor 78 that has an output shaft driving a shaft 77 on which a sprocket 79 is mounted. The chain 76 drives the sprocket 80 on the shaft or hub 74. The chain 76 and sprockets 79 and 80 are in a chain drive case 81. As shown in FIG. 7, one drive wheel section 72 is removed, and a wheel flange or hub 82 is shown and the drive disk 72A bolts onto this wheel flange or hub 82. The wheel flange or hub 82 is mounted on a common axle 84 that extends across the hub 74 and is driven by the sprocket 80.

It can be seen that the disk or drive wheel section 70 has a plurality of drive pins or bars 88, that are parallel to the axis of rotation and extend inwardly, and are spaced so that they will engage track lugs such as lugs 52. The drive wheel section 72 has drive pins 90 that have axes which are parallel to the axis of rotation as well. The axes of the pins or bars 90 are annularly offset from pins or bars 88 to be midway between the axes of the drive pins or bars 88, and would engage lugs 50 on a trade. The pins or bars of one drive wheel section are a half a pitch off from the pins or bars on the other drive wheels section. The drive bars on the wheel sections 70 and 72 will provide the same drive for the track as the drive bars 32 and 40 of the first form of the invention.

Thus, a split track drive wheel assembly is provided that has drive bars or pins that are spaced annularly a desired distance, which is the same as the spacing of the lugs that they are driving. The track lugs are in two rows with a space between the rows in the center, and also smooth spaces adjacent the track edges. The lugs in one row are offset one-half pitch from the lugs in the other row, and the drive wheel assemblies are made in two segments, with drive bars also offset from each other.

It also can be seen in FIG. 8 that the exterior ground-engaging tread lugs on the track 11 can be positioned to be in a desired location relative to the interior drive lugs to enhance the traction. It can be seen that the tread lugs 96 and 97 extend across the track. Adjacent lugs 96 have a wide spacing section 96A extending halfway across the track and are offset to form a narrow space section 96B extending across the other half of the track. The tread lugs 96 are alternated with the tread lugs 97 that are spaced to have a wide spacing portion 97A and offset to form a narrow space portion 97B that are reversed in orientation from the adjacent tread lugs 96. In other words, the wide space portions 96A of adjacent tread lugs 96 are between two narrow space portions 97B of adjacent lugs 97, and vice versa. Preferably, the drive lugs 50 and 52 are under the wide space portions of the tread lugs, as shown in FIG. 5. The drive lugs on the interior of the track can also be offset from the wide spaced portions of the tread lugs. The drive lug position will help to smooth out the loading of the track and aid in reducing vibrations and impact.

FIG. 8 also shows vehicle support frame members 100 connected to the track frame 12. The support frame members 100 are suitably mounted to a supporting vehicle frame 102 of a vehicle, such as a loader or tractor.

The motor shaft for driving the track can have a spring applied, pressure released brake 104 at an opposite end, to lock the drive when the valve to the brake is closed in response to a selected input signal. A traction lock device also can be used in place of a brake.

Although the present invention has been described with reference to preferred embodiments, workers skilled in the art will recognize that changes may be made in form and detail without departing from the spirit and scope of the invention.

1. An endless resilient material track for a track laying vehicle comprising an endless track having an interior and an exterior, a first row of spaced drive lugs adjacent one edge of the track, and a second row of spaced drive lugs adjacent a second side of the track, the drive lugs in the first drive, said second row of drive lugs being offset in a longitudinal direction of the track from the drive lugs in the first row of drive lugs.

2. The endless resilient material track of claim 1, wherein the track has a central longitudinal plane, and wherein the first and second row of drive lugs are both spaced laterally outwardly of the central longitudinal plane a selected amount.

3. The endless resilient material track of claim 1, wherein the sides of said track comprise longitudinal side edges on opposite sides thereof, the first and second row of drive lugs being spaced inwardly from the adjacent side edge a selected amount.

4. The endless resilient material track of claim 3, wherein said track outer surface has tread lugs formed thereon, and said tread lugs on the track outer surface are offset to form alternate wide and narrow spacing between the tread lugs in longitudinal direction.

5. The endless resilient material track of claim 4, wherein said tread lugs on the exterior of the track on one side of the longitudinal plane are alternating with the spacing of the tread lugs on the exterior of the opposite side of the longitudinal plane, whereby a narrow spacing between the tread lugs on one side of the track is laterally aligned with a wide spacing between the tread lugs on the opposite side of the track.

6. The endless resilient material track of claim 5, wherein the tread lugs on the exterior of the track extend across an entire lateral width of the track and have offset sections to provide the narrow and wide spacing.

7. A track for a track-laying vehicle used with a drive wheel for such track, the track having a series of drive lugs spaced along the length of the track, said drive lugs being divided into a first row of lugs spaced from a central longitudinal plane of the track on a first side of the plane, said drive lugs being spaced a first distance apart along the first row, and a second row of drive lugs spaced from the central longitudinal plane of the track on a second side of the plane, and the drive lugs in the second row being spaced the first distance apart, the drive lugs in the first row being offset longitudinally from the drive lugs in the second row, the offset being substantial one-half of the first distance.

8. The track of claim 6, wherein the drive lugs in both the first and second rows terminate short of respective lateral side edges of the track.

9. The track of claim 7, wherein the track and the drive lugs are molded as a unit.

10. The track of claim 7, wherein the drive wheel for such track has a pair of spaced wheel sections with drive bars at the periphery of each section, the drive bars having a surface to engage the lugs in a row of drive lugs aligned with a respective wheel section.

11. The track of claim 8, wherein the track is provided with an internal support, the internal support for the track including guide wheels that support lateral edges of the track adjacent and outwardly from the respective rows of drive lugs, and between the drive lugs and the respective side of the track, and in the space along the central longitudinal plane between the rows of drive lugs.

12. The drive track of claim 7, the drive wheel for such track comprises a drive wheel assembly comprising a pair of laterally separated drive wheel sections, each drive wheel section having drive bars annularly spaced around the periphery, the drive bars on a first of the drive wheel sections being at a first annular position, and having an annular spacing between them, and the drive bars on a second of the drive wheel sections being spaced the same annular space between them as the drive bars on the first drive wheel section, and being annularly offset from the drive bars of the first drive wheel section so that the drive bars of the first drive wheel section are substantially midway between the drive bars of the second drive wheel section.

13. A drive wheel assembly for driving an endless track, said endless track having drive lugs, said drive wheel assembly comprising a mounting hub and a pair of spaced apart supports extending radially outwardly from the hub, and drive bars at an outer periphery of each of the supports extending generally parallel to an axis of rotation of the drive wheels, said drive bars extending laterally of a center plane of the respective supports, and drive bars on one of the supports being offset in an annular direction from the drive bars on the other of the supports and positioned to engage different drive lugs of a track used with the drive wheel assembly.

14. The drive wheel assembly of claim 13, wherein the drive bars terminate spaced on opposite sides of a plane midway between the pair of spaced supports.

15. The drive wheel assembly of claim 14, wherein the pair of spaced supports extending radially comprise plates mounted on the mounting hub.
